(19) United States
(12) Patent Application Publication
(10) Pub. No.: US 2022/0343048 A1
(43) Pub. Date: Oct. 27, 2022

(54) DETERMINATION OF UNKNOWN BIAS AND DEVICE PARAMETERS OF INTEGRATED CIRCUITS BY MEASUREMENT AND SIMULATION

(71) Applicant: PROTEANTECS LTD., Haifa (IL)

(72) Inventors: Eyal FAYNEH, Givatayim (IL); Guy REDLER, Haifa (IL); Yahel DAVID, Kibbutz Gazit (IL); Inbar WEINTROB, Givat-Ada (IL); Evelyn LANDMAN, Haifa (IL)

(21) Appl. No.: 17/607,974

(22) PCT Filed: May 13, 2020
(86) PCT No.: PCT/IL2020/050519

§ 371 Date: Nov. 1, 2021

Related U.S. Application Data
(60) Provisional application No. 62/846,818, filed on May 13, 2019.

(51) Int. Cl. G06F 30/367

(52) U.S. Cl. CPC G06F 30/367; G06F 2111/08

(57) ABSTRACT

Determining one or more device parameters (Dp) of one or more parts of an integrated circuit (IC), including: simulating the IC; measuring one or more electrical characteristics of the one or more parts of the IC; using the one or more measured electrical characteristics of the one or more parts of the IC and the simulation to determine the one or more device parameters (Dp) of the one or more parts of the IC; for each part of the IC, determining a corresponding joint probability distribution of the one or more device parameters using the simulation; using maximum likelihood (ML) techniques to determine an estimate of the one or more device parameters; and using the one or more measured electrical characteristics of the one or more parts of the IC and the simulation to improve the estimate of the one or more device parameters.

### CROSS-REFERENCE TO RELATED APPLICATIONS

This application claims the benefit of priority to U.S. Provisional Patent Application No. 62/846,818, filed May 13, 2019, and entitled “Method and Device for Determining Unknown Bias and Device Parameters of Parts of Integrated Circuits”, the contents of which are incorporated herein by reference.

### FIELD OF THE INVENTION

The present invention relates to the field of integrated circuits.

### BACKGROUND

Integrated circuits (ICs) may include analog and digital electronic circuits on a flat semiconductor substrate, such as a silicon wafer. Microscopic transistors are printed onto the substrate using photolithography techniques to produce complex circuits of billions of transistors in a very small area, making modern electronic circuit design using ICs both low cost and high performance. ICs are produced in assembly lines of factories, termed foundries, which have commoditized the production of ICs, such as complementary metal-oxide-semiconductor (CMOS) ICs. Digital ICs contain billions of transistors arranged in functional and/or logical units on the wafer, with data-paths interconnecting the functional units that transfer data values between the functional units.

Determination of parameters relating to the devices and interconnects of the IC can be advantageous to improve operation of the IC. Moreover, the device parameters can be used for IC profiling, classification and outlier detection.

Existing circuits provide means by which to measure a current or bias indicative of device parameters. However, these require an external circuit to measure the current/bias and so require an analog pin to be provided.

Agents can be integrated with the IC to provide readouts of device and inter-connect parameters. However, existing methods for determining device and inter-connect parameters suffer from inaccuracies because of complex interactions and unknown systematic measurement biases in the IC.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods, which are meant to be exemplary and illustrative, not limiting in scope.

Some embodiments provide a method, a system, and a computer program product of determining one or more device parameters (Dp) of one or more parts of an integrated circuit (IC). The system comprises at least one processor and a non-transitory computer-readable storage medium having program code embodied therewith. The computer program product comprises a non-transitory computer-readable storage medium having program code embodied therewith. The method comprises, and the program code is executable for: simulating the IC; obtaining a measurement of one or more electrical characteristics of the one or more parts of the IC; using the one or more measured electrical characteristics of the one or more parts of the IC and the simulation to determine the one or more device parameters (Dp) of the one or more parts of the IC; for each part of the IC, determining a corresponding joint probability distribution of the one or more device parameters using the simulation; using maximum likelihood (ML) techniques to determine an estimate of the one or more device parameters; and using the one or more measured electrical characteristics of the one or more parts of the IC and the simulation to improve the estimate of the one or more device parameters.

Some embodiments provide a method, a system, and a computer program product of determining one or more device parameters (Dp) of one or more parts of an integrated circuit (IC), wherein the one or more device parameters of the one or more parts of the IC are subject to an initially unknown systematic bias. The system comprises at least one processor and a non-transitory computer-readable storage medium having program code embodied therewith. The computer program product comprises a non-transitory computer-readable storage medium having program code embodied therewith. The method comprises, and the program code is executable for: simulating the IC for each of a plurality of possible systematic biases to provide a plurality of corresponding simulations; for each systematic bias of the plurality of systematic biases, estimating a respective first device parameter of a first part of the IC from the corresponding simulation, such that a plurality of estimated device parameters is provided; obtaining a measurement of an electrical characteristic of the first part and determining a guided estimate of the first device parameter of the first part of the IC using the measured electrical characteristic; comparing the guided estimate of the first device parameter to each of the plurality of estimated first device parameters and determining a most likely systematic bias thereby; obtaining a measurement of one or more electrical characteristics of the one or more parts of the IC; and using the one or more measured electrical characteristics of the one or more parts of the IC and the simulation corresponding to the most likely systematic bias to determine the one or more device parameters (Dp) of the one or more parts of the IC.

Some embodiments provide a method, a system, and a computer program product of determining an initially unknown systematic bias in an integrated circuit (IC) wherein the IC comprises one or more parts having one or more device parameters, wherein the one or more device parameters of the one or more parts of the IC are subject to the systematic bias. The system comprises at least one processor and a non-transitory computer-readable storage medium having program code embodied therewith. The computer program product comprises a non-transitory computer-readable storage medium having program code embodied therewith. The method comprises, and the program code is executable for: simulating the IC for each of a plurality of possible systematic biases to provide a plurality of corresponding simulations; for each systematic bias of the plurality of systematic biases, estimating a respective first device parameter of a first part of the IC from the corresponding simulation, such that a plurality of estimated device parameters is provided; measuring an electrical characteristic of the first part and determining a guided estimate of the first device parameter of the first part of the IC using the measured electrical characteristic; and comparing the guided estimate of the first device parameter to each of the plurality of estimated first device parameters and determining a most likely systematic bias thereby.

In some embodiments, using the measured electrical characteristics to improve the estimate of the one or more device parameters determined using ML techniques comprises using maximum a posteriori (MAP) techniques to improve the estimate of the one or more device parameters.

In some embodiments, said one or more parts of the IC comprise one or more replica circuits; the one or more electrical characteristics of the one or more replica circuits replicate one or more electrical characteristics, respectively, of one or more sensitive circuits which are prone to malfunction if directly measured; and the method further comprises determining an improved estimate of one or more device parameters of the one or more sensitive circuits, based on the improved estimate of the one or more device parameters of the one or more replica circuits.

In some embodiments, the method further comprises, and the program code is further executable for, performing the measurement of the one or more electrical characteristics of the one or more parts of the IC, by: measuring a current (Id) indicative of the device parameter; using pulse generation circuitry to generate a pulse having a width, PW(Id), proportional to the measured current (Id); generating a reference current (IREF); using the pulse generation circuitry to generate a pulse having a width PW(IREF) proportional to the reference current (IREF); and calculating the ratio rₘ=PW(Id)/PW(IREF).

In some embodiments, the simulation comprises an estimator (f(r)) for each device parameter of each part, and wherein using the one or more measured electrical characteristics and the simulation to determine the one or more device parameters (Dp) of the one or more parts of the IC comprises: using the estimator (f(r)) and the ratio (rm) to estimate the device-parameter: Dp=f(rₘ).

In some embodiments, the method further comprises, and the program code is further executable for, performing the measurement of the one or more electrical characteristics of a part of the one or more parts of the IC, by: biasing the part to induce a condition of the part; and measuring an electrical characteristic of the part while the part is biased to induce the condition.

In some embodiments, the condition is selected from the group consisting of: saturation; weak inversion; subthreshold; and breakdown.

In some embodiments, the generating of the reference current (IREF) comprises: subtracting a feedback voltage from a reference voltage (VREF) to provide an input voltage; providing the input voltage to the input of a switched capacitor resistor; using an output of the switched capacitor resistor to provide the feedback voltage; and using the output of the switched capacitor resistor to generate the reference current (IREF).

In some embodiments, the method further comprises, and the program code is further executable for: allowing the reference current to become stable in a closed loop position with the feedback voltage being subtracted from the reference voltage so that the feedback loop is locked; and disconnecting the output of the switched capacitor from the feedback loop to provide an open-loop system.

In some embodiments, at least one of (a) the one or more device parameters and (b) the one or more expected device parameters, are selected from the group consisting of: a threshold voltage (Vth); a saturation current (Idsat); a leakage current (Ioff); a gate capacitance (Cgate); a diffusion capacitance (Cdiff); a metal resistance; a via resistance; a metal capacitance; a resistance of an analog device; a capacitance of an analog device; and device parameters for devices with unique channel length.

In some embodiments, the one or more parts are selected from the group consisting of: components; device structures comprising a plurality of components; interconnect paths; and analog devices.

In some embodiments, the systematic bias is a MOSCAP (Cm) bias.

In some embodiments, the first device parameter is a threshold voltage (Vth).

In some embodiments, the electrical characteristic of the first part is the device leakage current (Ioff).

In some embodiments, performing the measurement of an electrical characteristic of the first part and determining a guided estimate of the first device parameter of the first part of the IC using the measured electrical characteristic is performed prior to determining the systematic bias.

In some embodiments, performing the measurement of an electrical characteristic of the first part and determining a guided estimate of the first device parameter of the first part of the IC using the measured electrical characteristic comprises: measuring the device leakage current (Ioff) of the first device; and estimating the threshold voltage (Vth) of the first device using an estimator: f_{isub}(r)=freq(I_{sub_th})/f_{REF}.

In some embodiments, simulating the IC for each possible systematic bias to provide a corresponding simulation comprises: obtaining one or more expected device parameters from a database of device parameters for the one or more parts of the IC; simulating the IC by performing Monte-Carlo (MC) simulations using the possible systematic bias and the expected device parameters.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIGS. 1A and 1B illustrate block diagrams of the device and IC parameter extraction system.

FIG. 2 illustrates a circuit block diagram of the on-die device & IC parameters measurement circuit.

FIGS. 3A and 3B illustrate a circuit block diagram of the reference current generator.

FIG. 4 illustrates a switch capacitor resistor.

FIG. 5 illustrates a circuit for generating a reference current based on a switch capacitor and an inverting amplifier.

FIG. 6 illustrates two DUT structures examples.

FIG. 7 illustrates a pulse generator circuit.

FIG. 8 illustrates a MOSCAP (Cm) calibration circuit.

FIG. 9 illustrates a tpd calibration circuit.

FIG. 10 illustrates a Vfbk calibration circuit.

FIG. 11 illustrates a TDC calibration scheme.

FIG. 12 illustrates a hybrid TDC configuration.

FIG. 13 illustrates a SUM block and agent readout.

FIG. 14 illustrates a measurement timing sequence.

FIG. 15 illustrates test capacitance measurement.

FIG. 16 illustrates a M0 capacitor.

FIG. 17 illustrates measurement of RDUT.

FIG. 18 illustrates an M0 resistor.

FIG. 19 illustrates a VIA0 resistor.

FIG. 20 illustrates Idsat structures (ulvt-8 example).

FIG. 21 illustrates a systematic offset effect on measured Vgs (per MC point) on the plurality of simulations where the possible systematic bias is 0%, ±3% and ±5%.

FIG. 22 illustrates rms distances of each of a plurality of simulations vs. a Cm bias offset for that simulation (the possible systematic bias).

FIG. 23 illustrates a flowchart of a method of determining one or more device parameters of one or more parts of an integrated circuit.

### DETAILED DESCRIPTION

Disclosed herein is a technique, embodied in a method and a system, for determining one or more device parameters (Dp) of one or more parts of an integrated circuit (IC). The technique comprises simulating the IC, measuring or obtaining a measurement one or more electrical characteristics of the one or more parts of the IC, and using the one or more measured electrical characteristics of the one or more parts of the IC and the simulation to determine the one or more device parameters (Dp) of the one or more parts of the IC.

In this way, the determined one or more device parameters (Dp) of the one or more parts of the IC may be improved estimates over those provided by previous techniques.

The technique may thereby improve measurement accuracy by using data fusion.

Simulating the IC may comprise simulating a plurality of electronic circuits that are provided on the chip. These can be devices under test (DUTs) that measure Si (silicon) parameters which have a mutual distribution. The parameters can be dependent or independent. ML algorithms that are based on data-fusion and multi-dimensional techniques may be used to build estimators that are used to improve the accuracy of the Si measurement.

The profiling process matches a certain IC to a point in the manufacturing space. At Pre-Si (before the IC is implemented in silicon) the manufacturing point is represented by a global Monte-Carlo (MC) point. In order to return to the absolute MC point, the agent should measure the absolute value of a certain parameter. Any error in the estimation will affect the matching. Therefore, improvements in accuracy of parameter measuring as a result of the techniques provided by the present invention may provide improved matching and so improved profiling and matching Post-Si data to Pre-Si models.

The technique may further comprise, for each part of the IC, determining a corresponding joint probability distribution of the one or more device parameters using the simulation, using maximum likelihood (ML) techniques to determine an estimate of the one or more device parameters, and using the one or more measured electrical characteristics of the one or more parts of the IC and the simulation to improve the estimate of the one or more device parameters.

In other words, using the one or more measured electrical characteristics of the one or more parts of the IC and the simulation to determine an estimate of the one or more device parameters (Dp) of the one or more parts of the IC may comprise using the measured electrical characteristics to improve the estimate of the one or more device parameters determined using ML techniques.

Using the measured electrical characteristics to improve the estimate of the one or more device parameters determined using ML techniques may comprise using maximum a posteriori, MAP, techniques to improve the estimate of the one or more device parameters.

The one or more device parameters of the one or more parts of the IC may be subject to an initially unknown systematic bias. Simulating the IC may comprise simulating the IC for each of a plurality of possible systematic biases to provide a plurality of corresponding simulations. The technique may further comprise, for each systematic bias of the plurality of systematic biases, estimating a respective first device parameter of a first part of the IC from the corresponding simulation, such that a plurality of estimated device parameters is provided. The technique may further comprise measuring or obtaining a measurement of an electrical characteristic of the first part and determining a guided estimate of the first device parameter of the first part of the IC using the measured electrical characteristic. The technique may further comprise comparing the guided estimate of the first device parameter to each of the plurality of estimated first device parameters and determining a most likely systematic bias thereby. The simulation corresponding to the most likely systematic bias may be used to determine the one or more device parameters.

The systematic bias may be a MOSCAP (Cm) bias.

The first device parameter may be a threshold voltage (Vth).

The electrical characteristic of the first part may be the device leakage-current (Ioff).

Measuring an electrical characteristic of the first part and determining a guided estimate of the first device parameter of the first part of the IC using the measured electrical characteristic may both be performed prior to determining the systematic bias. This may be because the first device parameter may be estimated without prior knowledge of the systematic bias.

Measuring an electrical characteristic of the first part and determining a guided estimate of the first device parameter of the first part of the IC using the measured electrical characteristic may comprise: measuring the device leakage current (Ioff) of the first device; and estimating the threshold voltage (Vth) of the first device using an estimator, f_{isub}(r)=freq(I_{sub_th})/f_{REF}.

Simulating the IC for each possible systematic bias to provide a corresponding simulation may comprise: obtaining one or more expected device parameters from a database of device parameters for the one or more parts of the IC; and simulating the IC by performing Monte-Carlo (MC) simulations using the possible systematic bias and the expected device parameters.

Measuring one or more electrical characteristics of the one or more parts of the IC may comprise:
measuring a current (Id) indicative of the device parameter;
using pulse generation circuitry to generate a pulse having a width, PW(Id), proportional to the measured current (Id);
generating a reference current (IREF);
using the pulse generation circuitry to generate a pulse having a width PW(IREF) proportional to the reference current (REF);
calculating the ratio rₘ=PW(Id)/PW(IREF).

The simulation (or each simulation for each possible systematic bias) may comprise an estimator f(r) for each device parameter of each part. Using the one or more measured electrical characteristics and the simulation (i.e. the simulation corresponding to the most likely systematic bias) to determine the one or more device parameters (Dp) of the one or more parts of the IC may comprise using the estimator, f(r), and the ratio (rₘ) to estimate the device-parameter: Dp=f(rₘ).

Measuring one or more electrical characteristics of a part of the one or more parts of the IC may comprise: biasing the part to induce a condition of the part; and measuring an electrical characteristic of the part while the part is biased to induce the condition.

The condition may be selected from a list comprising: saturation; weak inversion; subthreshold; and breakdown.

Generating a reference current (IREF) may comprise:
subtracting a feedback voltage from a reference voltage (VREF) to provide an input voltage;
providing the input voltage to the input of a switched capacitor resistor;
using an output of the switched capacitor resistor to provide the feedback voltage; and
using the output of the switched capacitor resistor to generate the reference current (IREF).

Generating a reference current (IREF) may further comprise:
allowing the reference current to become stable in a closed loop position with the feedback voltage being subtracted from the reference voltage so that the feedback loop is locked; and
disconnecting the output of the switched capacitor from the feedback loop to provide an open-loop system.

Opening the IREF generation loop in this way can provide a more reliable reference current and so the device parameters may be more accurately determined.

One reason for this may be that current mirroring of the closed loop induces random variation to the output current due to the mirroring devices. This random variation is reduced in the open-loop version.

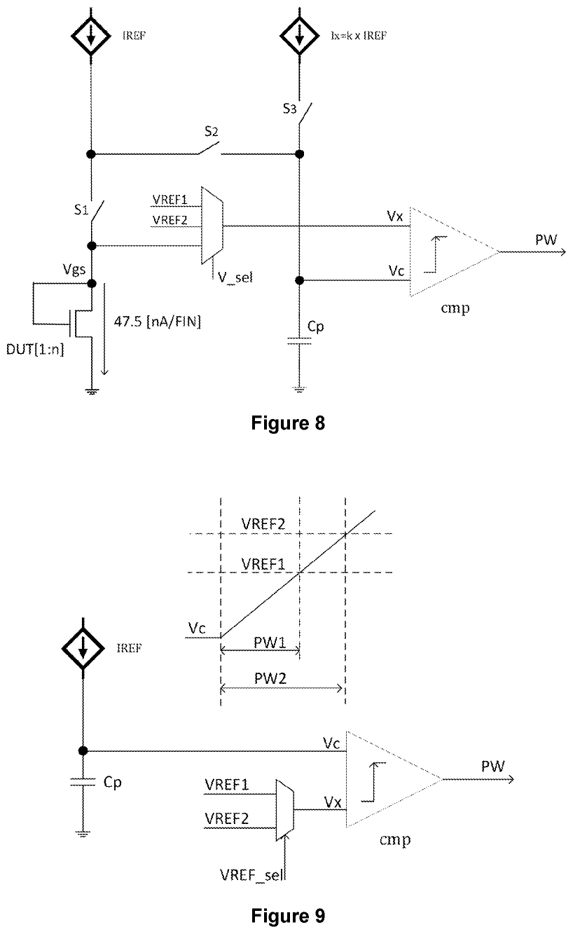

The closed-loop may be opened after the loop is locked and the current from the primary gm device (FIG. 8—gmo) may be used to charge the Cp.

There are two open loop modes: a) Measuring the Vgs->S1 is closed, S2 and S3 are open; b) Measuring the REF pulse->S2 is closed, s1 and S3 are open.

The one or more device parameters and/or the one or more expected device parameters may comprise one or more of: a threshold voltage (Vth); a saturation current (Idsat); a leakage current (Ioff); a gate capacitance (Cgate); a diffusion capacitance (Cdiff); a metal resistance; a via resistance; a metal capacitance; a resistance of an analog device; a capacitance of an analog device; and/or device parameters for devices with unique channel length.

The one or more parts may comprise one or more: components; device structures comprising a plurality of components; interconnect paths; and/or analog devices.

The present invention further provides a system configured to perform any of the methods and techniques described herein.

The present invention further provides a system configured to determine one or more device parameters (Dp) of one or more parts of an integrated circuit, by:
simulating the IC;
measuring one or more electrical characteristics of the one or more parts of the IC; and
using the one or more measured electrical characteristics of the one or more parts of the IC and the simulation to determine an estimate of the one or more device parameters (Dp) of the one or more parts of the IC.

The system may be further configured to:
for each part of the IC, determine a corresponding joint probability distribution of the one or more device parameters using the simulation;
use maximum likelihood (ML) techniques to determine an estimate of the one or more device parameters; and
use the one or more measured electrical characteristics of the one or more parts of the IC and the simulation to improve the estimate of the one or more device parameters.

The one or more device parameters of the one or more parts of the IC may be subject to an initially unknown systematic bias. Simulating the IC may comprise simulating the IC for each of a plurality of possible systematic biases to provide a plurality of corresponding simulations. The system may be further configured to determine the initially unknown systematic bias in the IC by:
for each systematic bias of the plurality of systematic biases, estimating a respective first device parameter of a first part of the IC from the corresponding simulation, such that a plurality of estimated device parameters is provided;
measuring an electrical characteristic of the first part and determining a guided estimate of the first device parameter of the first part of the IC using the measured electrical characteristic;
comparing the guided estimate of the first device parameter to each of the plurality of estimated first device parameters and determining a most likely systematic bias thereby, wherein the simulation corresponding to the most likely systematic bias is used to determine the estimate of the one or more device parameters.

The present invention further provides a system configured to determine an initially unknown systematic bias in an integrated circuit, IC. The IC comprises one or more parts having one or more device parameters. The one or more device parameters of the one or more parts of the IC are subject to the systematic bias. The system is configured to determine an initially unknown systematic bias by:
simulating the IC for each of a plurality of possible systematic biases to provide a plurality of corresponding simulations;
for each systematic bias of the plurality of systematic biases, estimating a respective first device parameter of a first part of the IC from the corresponding simulation, such that a plurality of estimated device parameters is provided;
measuring an electrical characteristic of the first part and determining a guided estimate of the first device parameter of the first part of the IC using the measured electrical characteristic;
comparing the guided estimate of the first device parameter to each of the plurality of estimated first device parameters and determining a most likely systematic bias thereby.

Any of the systems described above may further comprise the IC.

The present invention further provides a computer program containing instructions that, when executed by a processor of a computing device, cause the computing device to perform any of the methods described above.

The present invention also provides a method of determining an initially unknown systematic bias in an IC, wherein the IC comprises one or more parts having one or more device parameters, wherein the one or more device parameters of the one or more parts of the IC are subject to the systematic bias. The method comprises simulating the integrated electronic circuit IC for each of a plurality of possible systematic biases to provide a plurality of corresponding simulations. The method further comprises, for each systematic bias of the plurality of systematic biases, estimating a respective first device parameter of a first part of the integrated electronic circuit IC from the corresponding simulation, such that a plurality of estimated device parameters is provided. The method further comprises measuring an electrical characteristic of the first part and determining a guided estimate of the first device parameter of the first part of the integrated electronic circuit IC using the measured electrical characteristic. The method further comprises comparing the guided estimate of the first device parameter to each of the plurality of estimated first device parameters and determining a most likely systematic bias thereby.

Techniques described above in relation to determining device parameters may also be used in connection with this method of determining an initially unknown systematic bias.

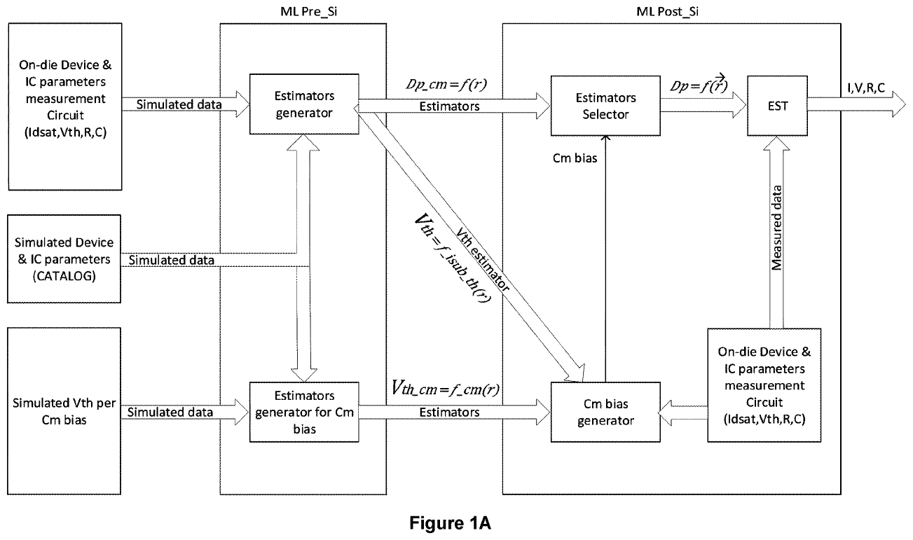

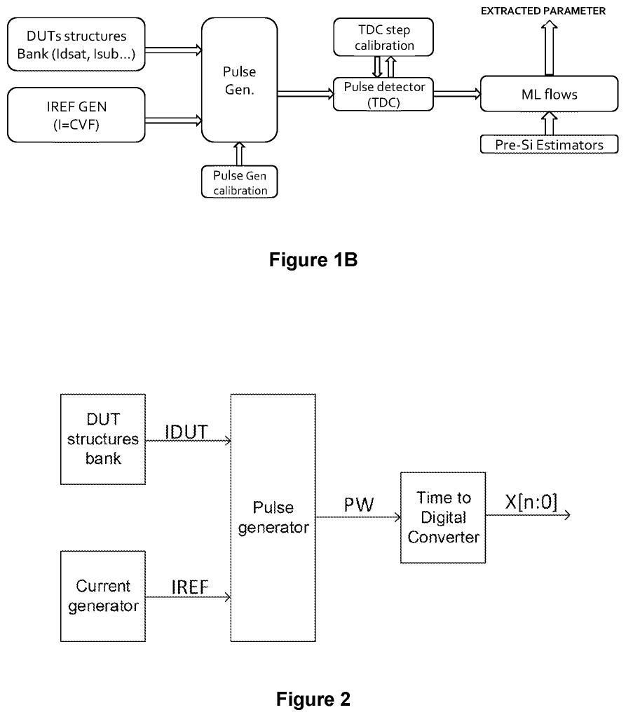

The present device and IC parameters extraction system, in some embodiments, is an agent that is used to measure absolute device and inter-connect parameters in high accuracy. These devices and inter-connect are also referred to herein as “parts” of the IC. The system may composed from on-die measurement circuit that generates digital readout, and offline calculation algorithms that are used to calibrate the on-die circuit, analyze the results and to increase the measurement accuracy of the system. FIG. 1 shows a block diagram of the system.

The on-die device & IC parameters measurement circuit block converts device parameters like MOS transistor threshold voltage (Vth) and MOS transistor Saturation-current (IDSAT) into a digital readout. The readout represents the absolute value of the device parameter measured at a certain Si. The circuit also converts inter-connect parameters like metal resistance & metal capacitance into a digital readout. The readout represents the absolute value of the inter-connect parameter measured at a certain Si. At the Pre-Silicon (Pre-Si) phase, the circuit is simulated over the manufacturing space represented by the global MC model to generate an input data for the ML estimator-generator block.

The Main measurement capabilities of the on-die device and IC parameters measurement circuit according to some examples of the present invention may include:
1. Measure device parameters: VTh, Idsat Ioff.
2. Measure device structures (serial devices) parameters: Idsat, Ioff.
3. Measure device Cgate.
4. Measure device Cdiff.
5. Measure metal resistance.
6. Measure via resistance.
7. Measure metal capacitance.
8. Measure analog resistor devices.
9. Measure analog capacitor devices.
10. Measure device parameters for devices with unique channel length.
11. Measure the device I/V curve behaviour (different width/fingers/fins).

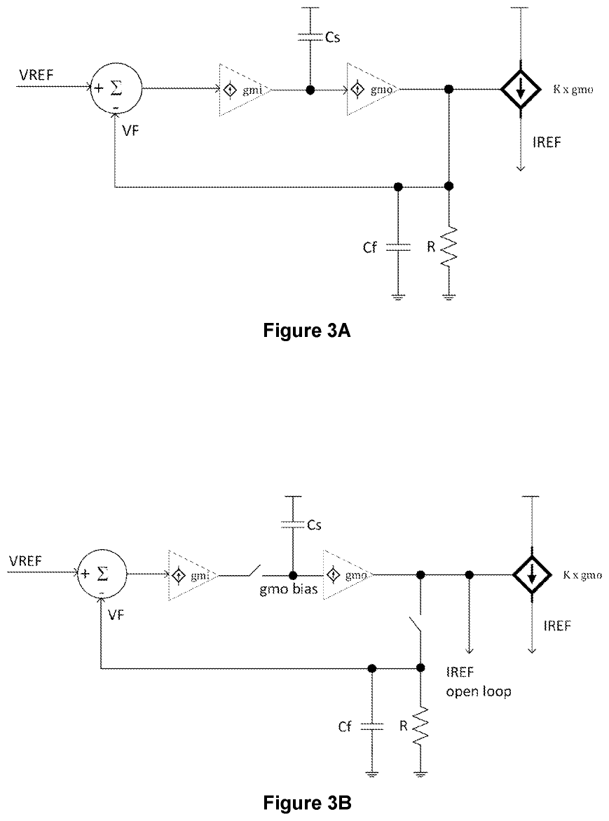

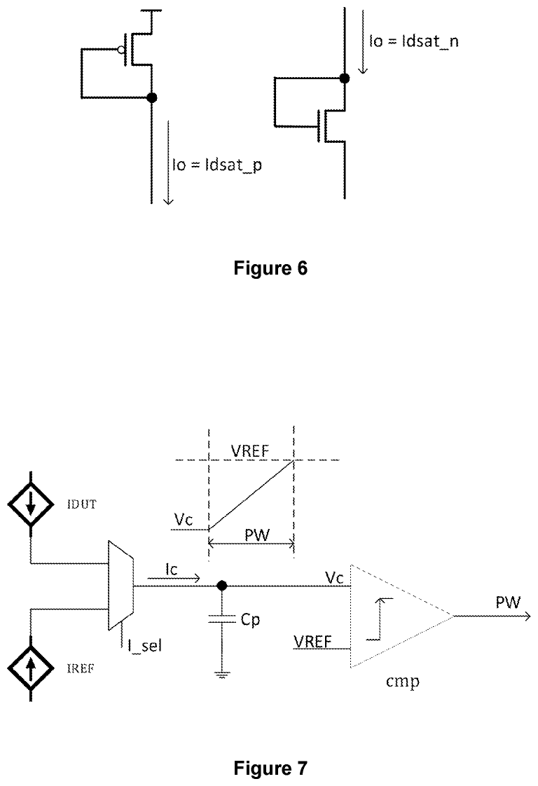

FIG. 2 shows a circuit block diagram of the on-die device and IC parameters measurement circuit. The circuit is built from four sub circuits:
1. Reference Current generator (FIG. 3).
2. Pulse generator (FIG. 6).
3. DUT structures bank.
4. Time-to-Digital Converter (TDC).

FIG. 3A illustrates the circuit block diagram of the reference current generator. The current-generator is based on a switch capacitor resistor. Its principal of operation is based on the principle that a constant resistor can be generated by switching a known capacitance in a constant frequency. The capacitor that is used in this circuit is a MOS capacitor (Cm). The MOS capacitor is varied with the manufacturing space, the capacitance variation will change the current amplitude. The effect can be simulated by running a global Monte-Carlo (MC) simulation on the MOS capacitor.

The IREF generator can be operated in open-loop mode to increase the reference current accuracy. In doing so, the measurement accuracy may be increased. FIG. 3B illustrates a circuit diagram of the reference current-generator operating in open-loop mode. At this mode, gmo is driving directly the reference current that is used for the measurement to mitigate the current mirroring (k×gmo) error that is caused by random variation. As a first step, the IREF loop (FIG. 3A) is locked, and then opened by disconnecting the feedback (gmo to VF). The current generated by gmo will be stable along the pulse-generation period since the gmo bias is fixed.

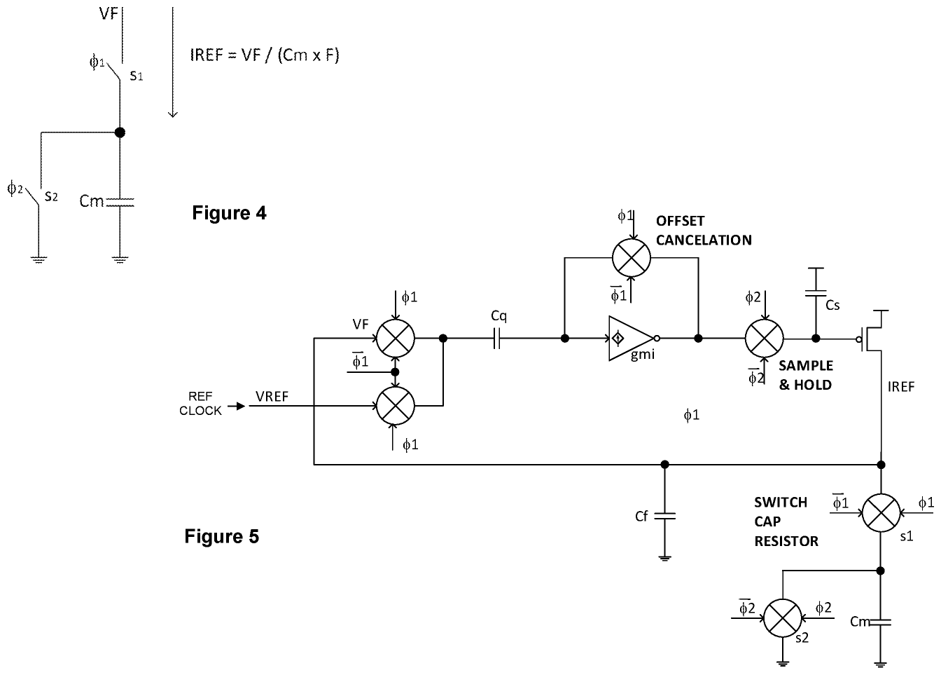

FIG. 4 illustrates the circuit block diagram of the switch capacitor resistor, Φ1 and Φ2 are two complementary and non-overlapped clock phases at frequency F. The two clock phases control switches s1 and s2. Cm is the MOS capacitor.

FIG. 5 illustrates Iref_gen based on switch cap and inv amplifier.

FIG. 6 illustrates an example block diagram of the DUT structures bank. The DUT structures bank includes individual circuits whose output current that are to be measured. For example, the DUT structures bank may include a MOS device biased at saturation conditions to generate saturation current. FIG. 6 illustrates an example of two device structures: a PMOS device structure and an NMOS device structure.

The pulse generator is illustrated in FIG. 7. The Pulse generator generates a pulse such that its width corresponds to current amplitude. The circuit operates at two modes: In mode 1, the input multiplexer (mux) selects the IREF current, the output pulse width is equal to PWREF=Cp×VREF/MREF. In mode 2, the input mux selects the DUT current (IDUT), the output pulse-width is equal to PWDUT=Cp×VREF/IDUT. Since the IREF amplitude is known, the DUT current can calculated as: IREF×(PWREF/PWDUT). Systematic offset will be cancelled since the same circuit is used to convert the current into a pulse width. VREF may be provided by a trimmable voltage divider.

The digital time conversion circuit converts the PW into a digital readout. The calculation of IDUT is a digital calculation based on the TDC readout.

### Calibration Modes

FIG. 8 illustrates the MOSCAP (Cₘ) calibration circuit. The MOSCAP (Cₘ) calibration process is used to detect systematic offset in Cₘ with respect to its average simulated typical value. Cₘ represents a capacitance of a P-device that is connected as a MOSCAP. The drain and source are connected to VDD. Therefore, the Cₘ value corresponds to a certain manufacturing point for the IC.

The calibration process is based on Si measurements and ML algorithms. The MOSCAP (Cₘ) calibration process is performed on a large sample of dies at the beginning of life and updated when needed. The circuit that support the MOSCAP (Cₘ) calibration is described at FIG. 8. During the calibration process the agent generates two readouts. The 1^{st} readout is the pulse-width (PW₁) that is generated when the reference voltage Vx is Vgs. Vgs is generated when the reference current (IREF) is driven to a diode-connected device (DUT<n:1>) to develop Vgs(Iref) voltage. At this mode S1 and S3 are closed, S2 is open. The 2^{nd} readout is the pulse-width (PW₂) that is generated when the reference voltage Vx is VREF1 and the charge current is Ix. The average IREF is then estimated using Pre-Si estimator functions based on PW₁/PW₂ ratio. The DUT multiplier is designed such that each fin will drive the same current as the device implemented in a catalog (described in more detail below) i.e. 50 nA/Fin; For an IREF amplitude of 10 μA, n=100. For better estimation error the Vgs voltage measurement can be executed at multi points (n:1, n/2:1, n/4:1).

Improved accuracy may be achieved by opening the IREF generation loop:
Mirroring the close loop current will induce random variation to the output current due to the mirroring devices.
Opening the close-loop after the loop is locked and using the current from the primary gm device (FIG. 8—gmo) to charge Cp.
As shown in FIG. 8, there are two open loop modes: a) Measuring the Vgs->Si is closed, S2 and S3 are open; b) Measuring the REF pulse->S2 is closed, s1 and S3 are open.

FIG. 9 illustrates how the comparator response time (t_{pd}) is calibrated. The comparator response time (t_{pd}) affects the pulse-width measurement accuracy. To mitigate this effect, the comparator response time (t_{pd}) is measured per die. The measurement circuit is illustrated in FIG. 9. During the calibration process the agent generates two readouts. The 1^{st} readout is the pulse-width (PW₁) that is generated when the reference voltage Vx is VREF1. The 2^{nd} readout is the pulse-width (PW₂) that is generated when the reference voltage Vx is VREF2. The comparator response time (t_{pd}) is calculated based on the two readouts:

$$\frac{P {W}_{1} - {t}_{p d}}{P {W}_{2} - {t}_{p d}} = \frac{V r e {f}_{1}}{V r e {f}_{2}} .$$

Comparator response time (tpd) may be measured per input current (per DUT).

In order to remove the random variation of a DUT, the DUT is implemented from multiple instances.

To measure a parameter, each of the instances is measured and summed with the last results (S=M1+M2+ . . . +Mn).

The parameter value is calculated offline and equal to S/n.

This technique allows to measure other aspects of the parameter, for example the standard deviation of the parameter.

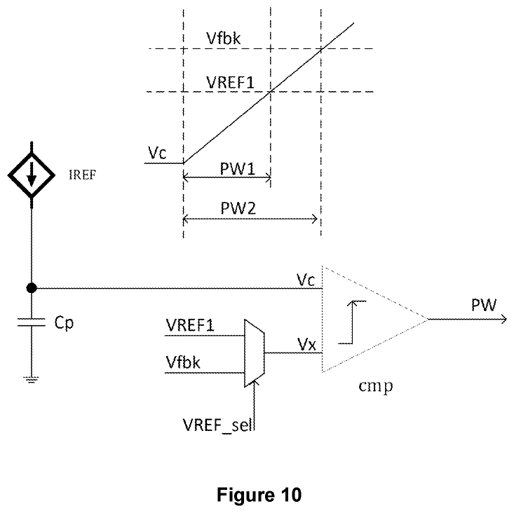

FIG. 10 illustrates feedback voltage calibration. The loop feedback voltage (V_{fbk}) affects the IREF generation accuracy. To mitigate the error the loop feedback voltage (V_{fbk}) is measured per-die and compared to an average value. The average value is measured based on a large sample of dies at the beginning of life and updated when needed. The measurement circuit is described at FIG. 10. To start the measurement, the agent is set to operate at open-loop in order to get a stable feedback voltage during the measurement. During the calibration process the agent generates two readouts. The 1^{st} readout is the pulse-width (PW₁) that is generated when the reference voltage Vx is VREF1. The 2^{nd} readout is the pulse-width (PW₂) that is generated when the reference voltage Vx is the loop feedback voltage (V_{fbk}). The loop feedback voltage (V_{fbk}) is calculated based on the two readouts:

$$\frac{{PW}_{1}}{{PW}_{2}} = \frac{{Vref}_{1}}{{V}_{fbk}}$$

$${Iref}_{error} = ( {V}_{fbk} - {V}_{{fbk}_{avg}} ) / {V}_{fbk} .$$

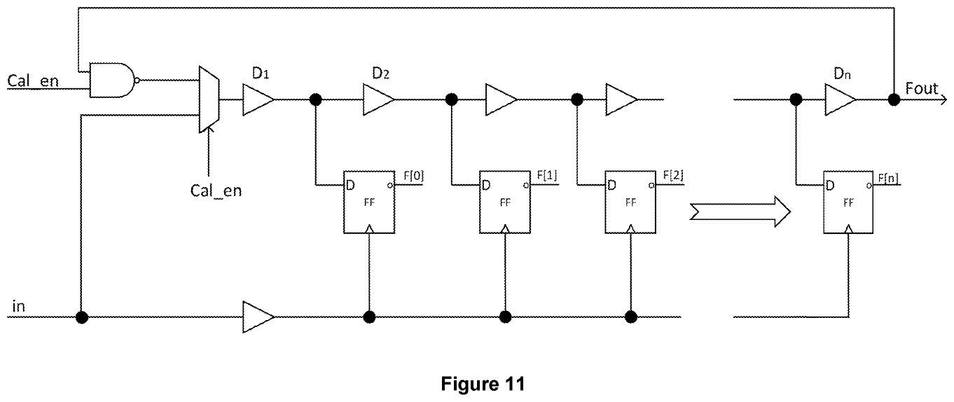

FIG. 11 illustrates the TDC calibration scheme. The TDC converts a pulse-width into a digital readout by measuring the number of TDC-buffers within the pulse timing interval. The accuracy of the measurement is 1-TDC buffer. The TDC-buffer delay is changing vs. process point so for absolute pulse-width measurements the TDC-buffer delay needs to be known. At the calibration process, the TDC delay-line is configured to a Ring-oscillator (cal_en=1), then the ring-oscillator frequency is measured. The average TDC buffer delay is calculated as follows:

$$D {i}_{a v g} = \frac{1}{{f}_{o u t} \times n} .$$

The agent can be operated in the measurement modes listed in Table 1:

TABLE 1

| Mode # | Type | Parameters | Output | Comments | Tm | |
|---|---|---|---|---|---|---|
| 1 | cmp tpd cal | IREF, | PW1 | Used for cmp tpd | 2 | ns |
| | | VREF1 | | measurement @ | | |
| | | | | close loop | | |
| 2 | cmp tpd cal | IREF, | PW2 | Used for cmp tpd | 2 | ns |
| | | VREF2 | | measurement @ | | |
| | | | | close loop | | |
| 3 | Cm Cal | IREF, Ix, | PW1 | Used for Cm | 20 | ns |
| | | Vgs | | systematic offset | | |
| | | | | measurement @ | | |
| | | | | close loop | | |
| 4 | Cm & tpd | Ix, V_{REF}1 | PW1 | Used for Cm | 20 | ns |
| | Cal | | | systematic offset | | |
| | | | | measurement & cmp | | |
| | | | | tpd @ close loop | | |
| 5 | cmp tpd | Ix, V_{REF}2 | PW2 | Used for cmp tpd | 20 | ns |
| | cal | | | measurement @ | | |
| | | | | close loop | | |
| 6 | Cm Cal | IREF, Ix, | PW1 | Used for Cm | 20 | ns |
| | | Vgs | | systematic offset | | |
| | | | | measurement @ | | |
| | | | | open loop | | |
| 7 | Cm Cal | Ix, V_{REF}1 | PW2 | Used for Cm | 20 | ns |
| | | | | systematic offset | | |
| | | | | measurement & cmp | | |
| | | | | tpd @ open loop | | |
| 8 | Vfb Cal | IREF, Vfbk | PW1 | Used for Vfbk | 20 | ns |
| | | | | systematic offset | | |
| | | | | measurement @ | | |
| | | | | Open-loop | | |
| 9 | TDC Cal | TDC freq | Freq | Used for absolute | 20 | ns |
| | | | | PW measurements | | |
| 10 | cmp tpd Cal | IDUT, | PW1 | Used for DUT | 2 | ns |
| | | VREF1 | | characterization per | | |
| | | | | representative DUT | | |
| 11 | cmp tpd Cal | IDUT, | PW2 | Used for DUT | 2 | ns |
| | | VREF2 | | characterization per | | |
| | | | | representative DUT | | |
| 12 | Op | IDUT, | PW1 | Used for DUT | 2 | ns |
| | | VREF1 | | characterization | | |

### Device Parameter Extraction Based on ML

The catalog is a set of simulated device and IC operational parameters for specific devices (Dp). The device parameters are simulated over the manufacturing space by performing Monte-Carlo (MC) simulations. For example, the catalog includes MC data of the saturation current of a certain device (IDSAT), leakage current of a certain device (Ioff) and the like.

In a general sense, a method of determining one or more device parameters (Dp) of one or more parts of an integrated circuit, IC, is provided. The method comprises the steps of:
1. simulating the one or more parts of the IC to provide one or more corresponding simulations;
2. measuring one or more electrical characteristics of the one or more parts of the IC; and
3. using the one or more measured electrical characteristics of the one or more parts of the IC and the corresponding simulation to determine an estimate of the one or more device parameters (Dp) of the one or more parts of the IC.

The method may further comprise:
4. for each part of the IC, determining a corresponding joint probability distribution of the one or more device parameters using the corresponding simulation; and
5. using maximum likelihood (ML) techniques to determine an estimate of the one or more device parameters.

Using the one or more measured electrical characteristics of the one or more parts of the IC and the corresponding simulation to determine an estimate of the one or more device parameters (Dp) of the one or more parts of the IC may comprise using the measured electrical characteristics to improve the estimate of the one or more device parameters determined using ML techniques.

Using the measured electrical characteristics to improve the estimate of the one or more device parameters determined using ML techniques may comprise using maximum a posteriori (MAP) techniques to improve the estimate of the one or more device parameters.

In a general sense, a method of determining one or more device parameters (Dp) of one or more parts of an integrated circuit, IC, is provided. The one or more device parameters of the one or more parts of the IC are subject to an initially unknown systematic bias. The method comprises the steps of:
1. measuring one or more electrical characteristics of the one or more parts of the integrated electronic circuit; and
2. using the one or more measured electrical characteristics and a simulation to determine the one or more device parameters (Dp) of the one or more parts of integrated electronic circuit.

A number of different simulations are calculated for a range of possible systematic offsets pre-Si. Post-Si, the most likely systematic offset is determined, and the corresponding simulation is selected. This simulation can be used with the measured electrical characteristics to provide a maximum a posteriori (MAP) estimation of the one or more device parameters.

Optionally, the number of different simulations which are calculated for a range of possible systematic offsets pre-Si can be used to generate an estimator for the device parameters. Without dividing the procedure into two parts (estimating/finding the bias and estimating the device parameters given the bias).

Measuring one or more electrical characteristics of the one or more parts of the integrated electronic circuit may comprise:
1. measuring a current (Id) indicative of the device parameter;
2. using pulse generation circuitry to generate a pulse having a width, PW(Id), proportional to the measured current (Id);
3. generating a reference current (REF);
4. using the pulse generation circuitry to generate a pulse having a width PW(IREF) proportional to the reference current (IREF); and
5. calculating the ratio, rₘ=PW(Id)/PW(IREF).

Each of the plurality of corresponding simulations may comprise an estimator f(r) for each device parameter of each part.

Using the one or more measured electrical characteristics and the simulation corresponding to the most likely systematic bias to determine the one or more device parameters (Dp) of the one or more parts of integrated electronic circuit may comprise using the estimator, f(r), and the ratio, rₘ, to estimate the device-parameter: Dp=f(rₘ).

Measuring one or more electrical characteristics of a part of the one or more parts of the integrated electronic circuit may comprise:
1. biasing the part to induce a condition of the part; and
2. measuring an electrical characteristic of the part while the part is biased to induce the condition.

The condition may be selected from a list comprising:
1. saturation;
2. weak inversion;
3. subthreshold; and
4. breakdown.

The one or more device parameters and/or the one or more expected device parameters may comprise one or more of:
1. a threshold voltage (Vth);
2. a saturation current (Idsat);
3. a leakage current (Ioff);
4. a gate capacitance (Cgate);
5. a diffusion capacitance (Cdiff);
6. a metal resistance;
7. a via resistance;
8. a metal capacitance;
9. a resistance of an analog device;
10. a capacitance of an analog device;
11. device parameters for devices with unique channel length.

The one or more parts may comprise one or more:
1. components;
2. device structures comprising a plurality of components;
3. interconnect paths; and
4. analog devices.

Flow description for device parameter extraction:
1. The Device-parameter (Dp) is converted into current: Id;
2. Id is converted into a Pulse-Width by a Pulse-Gen circuit: PW(Id);
3. The Pulse-Gen circuit generates a pulse based on IREF: PW(IREF);
4. The ratio r=PW(Id)/PW(IREF) is calculated to remove the PW-Gen circuit systematic offset;
5. An Estimator Dp=f(r) is build based on the simulated Monte-Carlo (MC) values of the ratio (r) and the device-parameter Dp. The MC simulations are performed per Cₘ offset;
6. At Post_Si, the ratio r is measured (rₘ) and the Pre-Si estimator f(r) is used to estimate the device-parameter: Dp=f(rₘ);
7. Optionally, additional readouts may be used for the estimator, then, Dp=f(r,x), and Dp=f(r_m,x_m), where x are the additional simulated readouts, and x_m are their measured values.

The IC comprises one or more parts having one or more device parameters. The one or more device parameters of the one or more parts of the IC are subject to the systematic bias.

In a general sense, the method of determining the initially unknown systematic bias in the IC comprises the following steps:
1. simulating the integrated electronic circuit for each of a plurality of possible systematic biases to provide a plurality of corresponding simulations;
2. for each systematic bias of the plurality of systematic biases, estimating a respective first device parameter of a first part of the integrated electronic circuit from the corresponding simulation, such that a plurality of estimated device parameters is provided;
3. measuring an electrical characteristic of the first part and determining a guided estimate of the first device parameter of the first part of the integrated electronic circuit using the measured electrical characteristic; and
4. comparing the guided estimate of the first device parameter to each of the plurality of estimated first device parameters and determining a most likely systematic bias thereby.

The systematic bias may be a MOSCAP (Cₘ) bias.

Measuring an electrical characteristic of the first part and determining a guided estimate of the first device parameter of the first part of the integrated electronic circuit using the measured electrical characteristic is performed prior to determining the systematic bias. In other words, the guided estimation of the threshold voltage may be obtained even though the systematic bias is unknown (because the value is determined in such a way that the systematic bias term is cancelled out from the equation). However, the value of the threshold voltage (Vth) is affected by the systematic bias and therefore the guided estimation can be compared to the simulations and used to determine the most accurate simulation and so determine the best estimate for the value of the systematic bias.

Additionally, another method of determining the initially unknown systematic bias in the IC comprises the following steps:
1. simulating the integrated electronic circuit for each of a plurality of possible systematic biases to provide a plurality of corresponding simulations;
2. measuring an electrical characteristic of a first part of the IC; and
3. generating an estimator or a classifier of the systematic bias and determining a most likely systematic bias thereby.

The systematic bias may be a MOSCAP (Cₘ) bias.

Simulating the integrated electronic circuit for each possible systematic bias to provide a corresponding simulation may comprise:
1. obtaining one or more expected device parameters from a database of device parameters for the one or more parts of the integrated electronic circuit; and
2. simulating the integrated electronic circuit by performing Monte-Carlo (MC) simulations using the possible systematic bias and the expected device parameters.

ML-based IREF systematic offset cancelation:
At Pre-Si:
   Run MC simulation per Q to generate an Estimator for Vth:

1. Vth_{cm}=f_{cm}(r), r=PW₁/PW₂
2. PW₁: Simulated PW based on Ix & Vref voltage level
3. PW₂: Simulated PW based on Ix & DUT's Vgs voltage level
At Post-Si:
   1. Estimate Vth by a different Vth Estimator (Type 2)

−Vth=f_{isub_th}(r), r=freq(I_{sub_th})/f_{REF})
2. Estimate Vth_{cm} by using the f_{cm}(r) Estimators and the measured ratio r
3. By comparing Vth from both Estimators f_{isub_th}(r), f_{cm}(r) estimate Cₘ offset
Estimate Dp with the Estimator f(rₘ) that was generated by the MC simulation corresponds to the estimated Cₘ offset.

The type-2 Vth estimator is based on sensing/converting the device leakage current (Ioff) into a digital readout. The leakage current is the sub-threshold current in the MOS transistor between the source and drain when the MOS transistor is OFF. The sub-threshold current of a MOSFET device when the transistor is at the sub-threshold region, i.e. gate-to-source voltage is below the threshold voltage. The sub-threshold current is significantly affected by the device threshold-voltage and hence has a good correlation to Vth.

Estimating Vth based on Ioff is done based on the estimator: Vth=f_{isub}(r).

More details on leakage current sensing can be found at PCT Publication No. WO 2019/125247, entitled “Integrated Circuit Workload, Temperature and/or Sub-Threshold Leakage Sensor”.

Estimation noise may be reduced by using common information manifested by different Vth-type devices. The ML algorithm is used to reduce the estimation noise by using input data from the different Vth-type devices. For example, estimating Idsat based on multi Vth device data. Idsat is approximately a function of two parameters K and vt. The vt parameter is varied across VT types. By using the type-2 Vth Estimator (using the HIPs ratios), the vt parameter can be estimated with high accuracy. The K parameter is highly correlated between different VTs, but per VT, the correlation is low and so the estimation accuracy is low. High Idsat estimation accuracy is obtained by using all VTs for estimating the K parameter.

The agent uses two input clocks, PRTN clock & rlclk clock. The agent-core circuits (TREF generator and PW generator) are clocked by a divided version of the rlclk clock. The divided clock frequency may be 100 MHz, merely as an example. For area improvement, the agent may support operation at 200 MHz, for example.

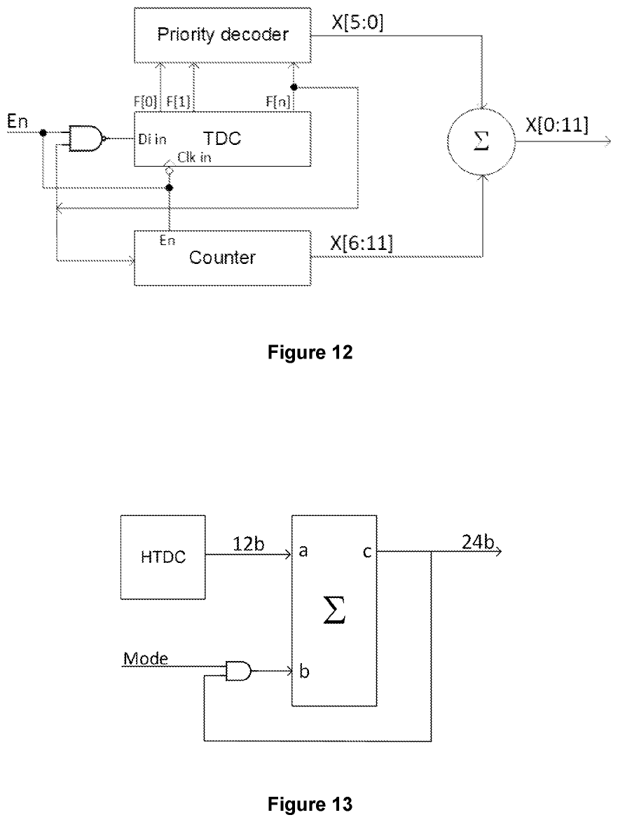

The TDC block is used to measure the pulse-width generated by the pulse-generator block. In some examples, the agent may use a Hybrid TDC (HTDC). The HTDC is described at FIG. 12. The HTDC is composed of a delay-line based TDC and counter. The length of the delay-line based TDC is 64 cells that decode to 6b, X[7:0]. The counter is counting the number of times that the delay-line based TDC has overflown. The counter output is 6b that represents the MSB part of the HTDC readout. The full readout represents the measured pulse width time interval, X[11:0].

The max pulse width time interval in one example is calculated by:

TDC step=10 ps, Max PW=[2\hat{ }12×10 ps]=40 [ns].

The HTDC readout (agent readout) may be averaged for accuracy. In order to avoid complex logic implementation, the HTDC readout may be averaged offline. To enable offline averaging the HTDC readout is summed on-die and generates two readouts: 1. Sum of measurements 2. Number of measurements. The SUM block function (and agent readout) is described at FIG. 13. If the mode signal is to equal [1], the SUM function is enabled. Max SUM value is generated by the summation of 64 repetitive measurements, and the size of the Max SUM value is 18 bits. The readout is generated per DUT.

In order to mitigate the DUT random variation each DUT-type may be multiplied up to 64 elements. Multiple DUT structures from the same type are summed to a one readout. To support multi-DUT summing 6 bits were added to the SUM block (output SUM size is 24 bits).

The TDC (Time to Digital Converter) converts a time-interval into a digital readout. The conversion accuracy is equal to 1-buffer-delay/Min-time-interval. The Min accuracy is equal to 10 ps/2000 ps=0.5% (2 ns equal to min-time interval).

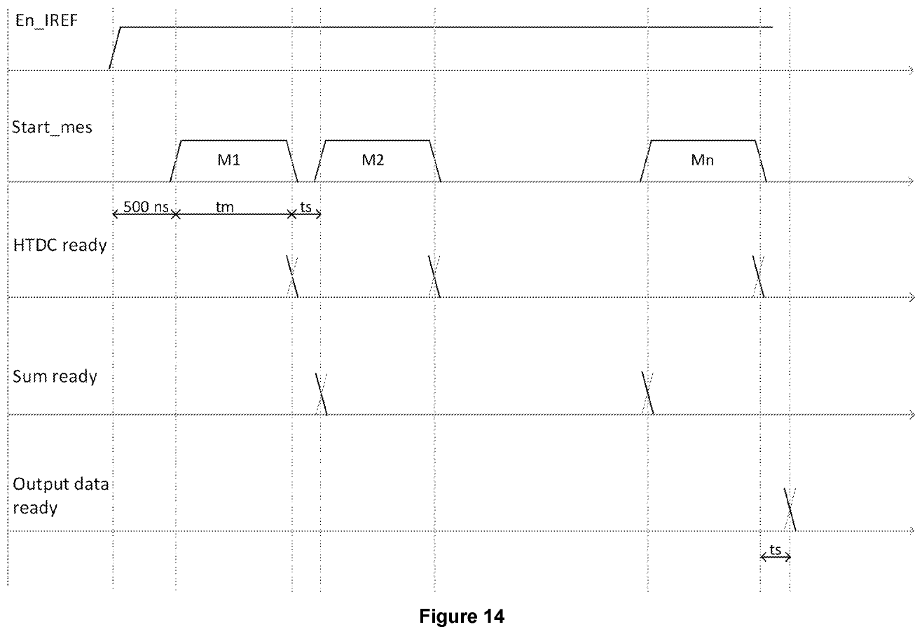

FIG. 14 illustrates the measurement sequence. The agent is enabled by the En_IREF signal. The agent is ready to measure after 500 ns which is the agent wakeup time. The measurement is activating by the rising edge of Start_mes signal. The measurement time interval tm is configurable per mode. Tm range is 1-to-8 clock phases i.e. 5 ns-to-40 ns @100 MHz input clock, and 1-16 clock phases @ 200 MHz clock. The HTDC readout is ready at the end of the measurement time interval (tm). After ts the agent can start new measurement. ts time interval is one clock phase (2.5 ns @ 200 MHz input clock or 5 ns @100 MHz input clock). The SUM operation is ready after ts. After n-measurement cycles the output-data is ready to be read.

Table 2 shows the total number of bits generated by the agent and the agent total measurement time in two scenarios:

### 1st Scenario:

Number of DUTs: 24, support Idast measurement of n-devices and p-devices of 3-VTs type and 2-channel length types, of 1-device structure and 2-serial device structure. Averaging 64 devices. Averaging 64 measurements.
2nd scenario:
Number of DUTs: 12, support Idast measurement of n-devices & p-devices of 3-VTs type & 2-channel length-types, of 1-device structure. Averaging 32 devices. Averaging 32 measurements.

In both cases the agent output data size is 24 bits. The minimum measurement time per DUT is 10 ns, determined by the 100 MHz clock cycle time.

TABLE 2

| | Max | Min |
|---|---|---|
| Number of DUTs | 24 | 12 |
| Number of instances per DUT from the same type | 64 | 32 |
| Agent clock frequency [MHz] | 100 | 100 |
| Total number of bits | 576 | 288 |
| Number of measurements | 64 | 32 |
| Measurement time per DUT [ns] | 10 | 10 |
| Total measurement time [us] | 983.04 | 122.88 |

The agent can support the measurement of device random variation. In this mode multiple DUTs from the same types are measured without averaging. The SUM function (FIG. 2) is configured to Mode=[0] to disable the SUM function. The SUM readout reflects the value of one measured DUT.

### Metal Capacitance Measurement (Ctest)

When the IREF is known, Cp can be calculated based on the measured PW. If Cp is known, other capacitance (Ctest) can be measured as follows:

$$\frac{P {W}_{1}}{P {W}_{2}} = \frac{C p}{C p + C t e s t} .$$

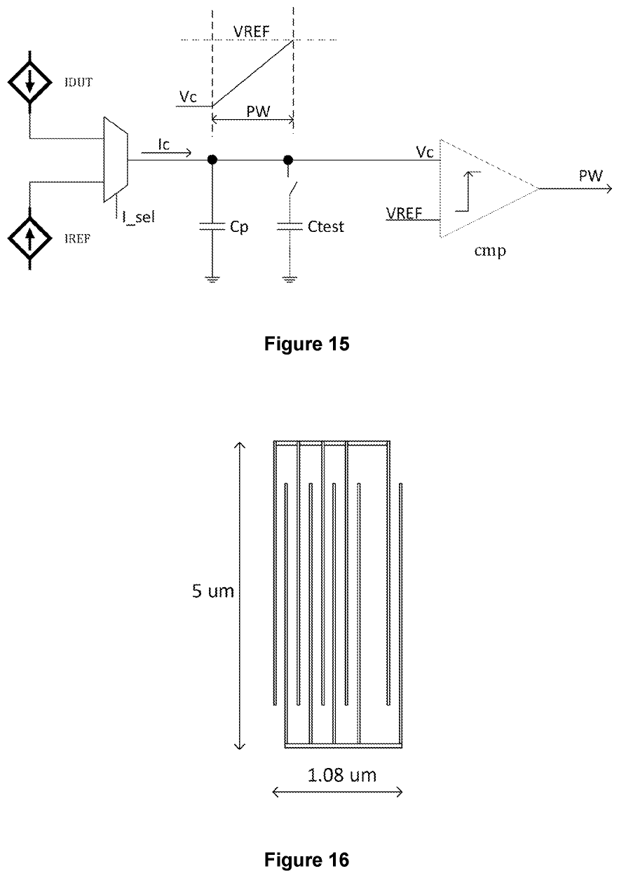

FIG. 15 illustrates test capacitance measurement.

FIG. 16 is an example for a Metal-Finger-Capacitor (MFC) based on M0. The MFC capacitance is designed to be 5% of Cp (Cp=1 pf).

### Metal Resistance Measurement

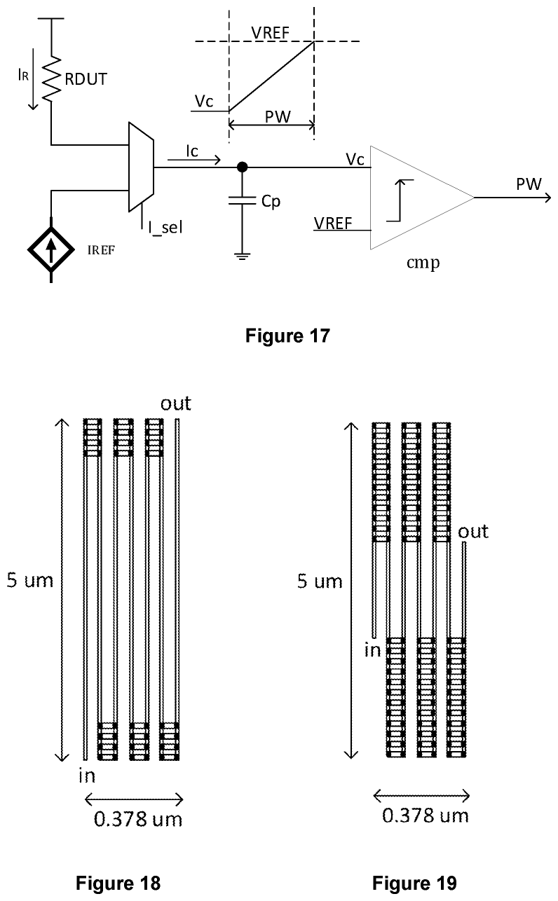

FIG. 17 illustrates the circuit that measures RDUT. RDUT is calculated as follows:

$$R D U T = \frac{P {W}_{1}}{P {W}_{2}} = \frac{V D D - V r e {f}_{1} / 2}{I R E F} .$$

FIGS. 18 and 19 are examples for a Metal-Resistor based on M0. The Metal-Resistor is designed to generate 300 [μA] i.e. 2 KΩ. The corresponding pulse width is expected to be 1 ns. FIG. 18 describes a M0 based resistor. FIG. 19 describes a VIA0 dominated resistor.

### Measurement of Analog Passive Elements

The agent can measure at least the following analog components:

NWELL resistor,
Metal capacitance.

### Measurement of Device I/V Curve Behaviour

The IREF generator implements an option to change the IREF current amplitude between a few discrete values. Measuring the Vgs value at different IREF amplitudes may be used for I/V curve characterization of a device.

### DUT Bank

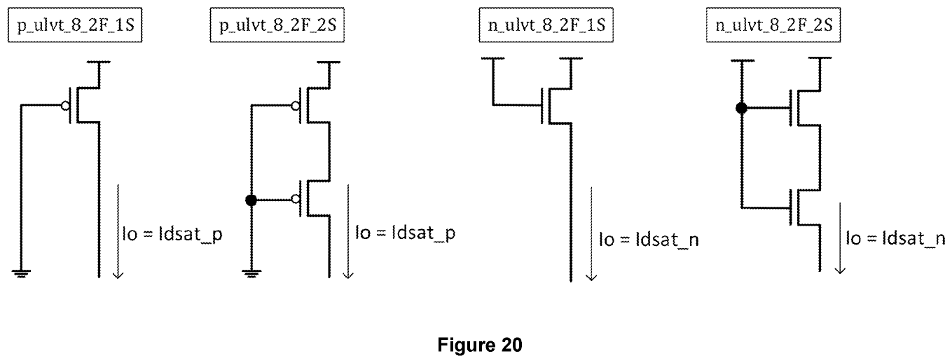

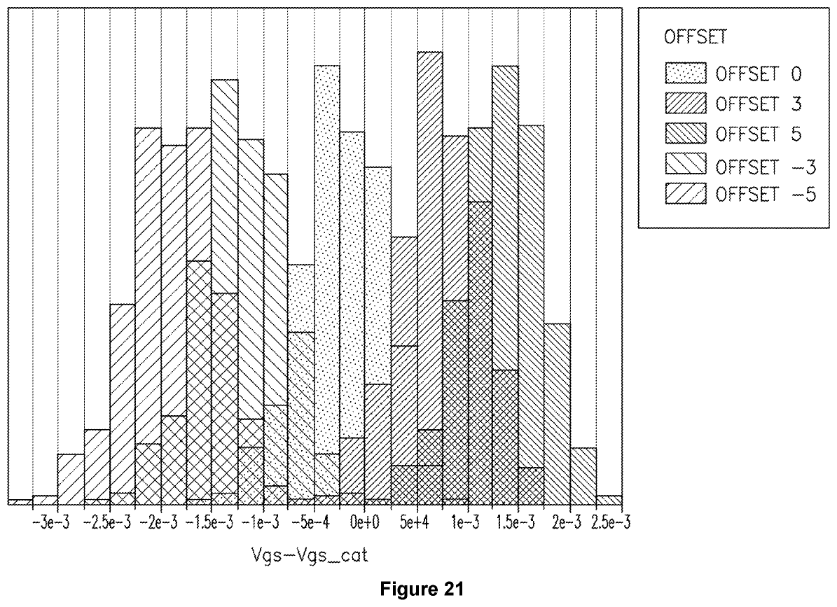

FIG. 20 illustrates device based DUTs-IDsat structures.

FIG. 21 illustrates the systematic offset effect on the measured Vgs per MC point. The plot shows the delta between the measured Vgs corresponding to Cₘ bias offsets of 0%, ±3% and ±5% to the Vgs generated from the Catalog based on IREF with 0% offset.

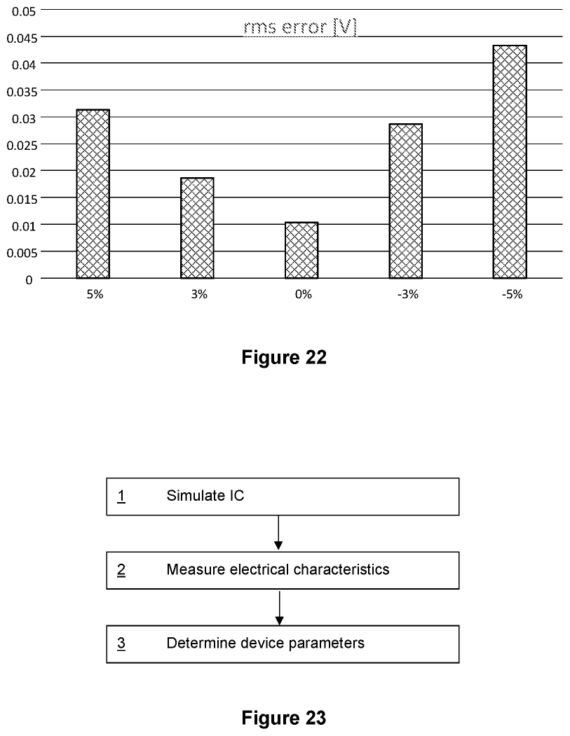

FIG. 22 illustrates the rms distances of each of the plurality of simulations when applying Cₘ bias offset of 0%, ±3% and ±5%. The ML will generate estimators per Cₘ bias. The estimator that will generate the lower rms value is representing the systematic bias of the Si. In this example, the lower rms value is generated by the estimator corresponds to 0% offset.

FIG. 23 illustrates a flowchart of a method of determining one or more device parameters (Dp) of one or more parts of an integrated circuit.
1. simulating the IC
2. measuring one or more electrical characteristics of the one or more parts of the IC; and
3. using the one or more measured electrical characteristics of the one or more parts of the IC and the simulation to determine the one or more device parameters (Dp) of the one or more parts of the IC.

In some embodiments, the IC part for which electrical characteristic measurement is desired is a sensitive circuit which is prone to malfunction if directly measured. Namely, for example, if the on-die device & IC parameters measurement circuit of FIG. 2 is electrically connected directly to that sensitive circuit, the sensitive circuit may be affected by the measurement and malfunction as a result of it. The malfunctioning may include, for example, changes in voltage and/or current at the sensitive circuit, or even physical damage if measurement is performed over extended durations. Aside from thwarting the correct operation of that sensitive circuit, such malfunctioning will of course make any measured parameters irrelevant.

To still be able to measure electrical characteristics of such sensitive circuit, the following solution may be provided: the IC may be designed and fabricated to include a replica of the sensitive circuit, and the measurements (and simulation, of course) are performed on the replica circuit instead of on the sensitive circuit itself. The replica circuit may be structurally and/or functionally equivalent, in terms of its electrical characteristics (e.g., voltage and/or current), to the sensitive circuit, such that measuring the replica circuit is equivalent to measuring the sensitive circuit. Accordingly, since it is expected that any form of bias (as discussed above) to the sensitive circuit will also be exhibited by the replica circuit, measuring just the replica circuit is an effective way of indirectly understanding how these parameters behave in the sensitive circuit.

In some embodiments, therefore, the physically measured IC part(s) is/are the replica circuit(s), and this provides for indirect measurement of corresponding sensitive circuits(s) of the IC. In these embodiments, some or all of the features of the invention discussed throughout this disclosure may be implemented by simply conducting every operation, whether Pre-Si or Post-Si, with respect to the replica circuit(s) instead of the sensitive circuit(s). Accordingly, these embodiments may further include determining an improved estimate of one or more device parameters of the one or more sensitive circuits, based on the improved estimate of the one or more device parameters of the one or more replica circuits.

For example, the improved estimate with respect to the one or more sensitive circuits may simply be determined to be equal to the improved estimate with respect to the one or more replica circuits. This is useful if the sensitive circuit(s) was/were designed and fabricated to exhibit exactly the same electrical characteristics of the sensitive circuit, in a 1:1 ratio.

In another example, which is useful if a replica circuit was designed and fabricated to exhibit a 1:x (x≠1) ratio of the electrical characteristics of the sensitive circuit, any measured electrical characteristic may first be multiplied by 1/x in order to normalize it to the corresponding electrical characteristic value of the sensitive circuit. After this normalization, the technique proceeds normally to determine, with respect to any replica circuit, the device parameters, the joint probability distribution, the estimated device parameters, and the improved estimate of the device parameters. Then, the improved estimate with respect to the corresponding sensitive circuit may be set as equal to the improved estimate with respect to the replica circuit, because a ratio of 1:1 between the two is a result of the earlier normalization step.

By way of example, a certain replica circuit may be designed and fabricated to exhibit any of voltage, current, capacitance, and resistance at a ratio of 1:x (x≠1) to the sensitive circuit on which it is based. In such a case, the measured voltage, current, capacitance, and/or resistance of that certain replica circuit must first be multiplied by 1/x to normalize it to the corresponding sensitive circuit.

One example of a sensitive circuit is a phase interpolator. Direct measurement of electrical characteristics of such phase interpolator is likely to affect its operation. Accordingly, by creating a replica of the phase interpolator and performing the measurements on the replica, the electrical characteristics of the phase interpolator can be indirectly measured without affecting its operation.

The system of embodiments of the invention, which is configured to perform one or more of the techniques and methods described herein, may be computer system which includes one or more hardware processors, a random-access memory (RAM), and one or more non-transitory computer-readable storage devices.

The storage device(s) may have stored thereon program instructions and/or components configured to operate the hardware processor(s). The program instructions may include one or more software modules, such as software modules that are configured to execute one or more of the techniques and methods described herein. The program components may include an operating system having various software components and/or drivers for controlling and managing general system tasks (e.g., memory management, storage device control, power management, etc.), and facilitating communication between various hardware and software components.

The computer system may operate by loading instructions of any of the software modules into the RAM as they are being executed by the processor(s). The instructions of any of the software modules may cause the computer system to simulate an IC according to the above discussions, obtain measurements of one or more electrical characteristics as discussed above (namely, the measurements may be performed by a separate measurement device that is either embedded in the IC or is external to the IC, and transmitted to the computer system for processing), and perform the various steps of estimation and determination discussed above.

This computer system, as described herein, is only an exemplary embodiment of the present invention, and in practice may be implemented in hardware only, software only, or a combination of both hardware and software. The computer system may have more or fewer components and modules than shown, may combine two or more of the components, or may have a different configuration or arrangement of the components. The computer system may include any additional component enabling it to function as an operable computer system, such as a motherboard, data busses, power supply, a network interface card, a display, an input device (e.g., keyboard, pointing device, touch-sensitive display), etc. (not shown). Moreover, components of system may be co-located or distributed, or the system could run as one or more cloud computing “instances,” “containers,” and/or “virtual machines,” as known in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

To clarify the references in this disclosure, it is noted that the use of nouns as common nouns, proper nouns, named nouns, and the/or like is not intended to imply that embodiments of the invention are limited to a single embodiment, and many configurations of the disclosed components can be used to describe some embodiments of the invention, while other configurations may be derived from these embodiments in different configurations.

In the interest of clarity, not all of the routine features of the implementations described herein are shown and described. It should, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

Based upon the teachings of this disclosure, it is expected that one of ordinary skill in the art will be readily able to practice the present invention. The descriptions of the various embodiments provided herein are believed to provide ample insight and details of the present invention to enable one of ordinary skill to practice the invention. Moreover, the various features and embodiments of the invention described above are specifically contemplated to be used alone as well as in various combinations.

Conventional and/or contemporary circuit design and layout tools may be used to implement the invention. The specific embodiments described herein, and in particular the various thicknesses and compositions of various layers, are illustrative of exemplary embodiments, and should not be viewed as limiting the invention to such specific implementation choices. Accordingly, plural instances may be provided for components described herein as a single instance.

While circuits and physical structures are generally presumed, it is well recognized that in modern semiconductor design and fabrication, physical structures and circuits may be embodied in computer readable descriptive form suitable for use in subsequent design, test or fabrication stages as well as in resultant fabricated semiconductor integrated circuits. Accordingly, claims directed to traditional circuits or structures may, consistent with particular language thereof, read upon computer readable encodings and representations of same, whether embodied in media or combined with suitable reader facilities to allow fabrication, test, or design refinement of the corresponding circuits and/or structures. Structures and functionality presented as discrete components in the exemplary configurations may be implemented as a combined structure or component. The invention is contemplated to include circuits, systems of circuits, related methods, and computer-readable medium encodings of such circuits, systems, and methods, all as described herein, and as defined in the appended claims. As used herein, a computer readable medium includes at least disk, tape, or other magnetic, optical, semiconductor (e.g., flash memory cards, ROM), or electronic medium and a network, wireline, wireless or other communications medium.

The foregoing detailed description has described only a few of the many possible implementations of the present invention. For this reason, this detailed description is intended by way of illustration, and not by way of limitations. Variations and modifications of the embodiments disclosed herein may be made based on the description set forth herein, without departing from the scope and spirit of the invention. It is only the following claims, including all equivalents, which are intended to define the scope of this invention. In particular, even though the preferred embodiments are described in the context of one of a number of specific circuit designs for a semiconductor IC, the teachings of the present invention are believed advantageous for use with other types of semiconductor IC circuitry. Moreover, the techniques described herein may also be applied to other types of circuit applications. Accordingly, other variations, modifications, additions, and improvements may fall within the scope of the invention as defined in the claims that follow.

Embodiments of the present invention may be used to fabricate, produce, and/or assemble integrated circuits and/or products based on integrated circuits.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. Combinations of features and/or aspects as disclosed herein are also possible, even between different embodiments of FPC or MFPC or other designs and/or drawings of other features. The terminology used herein was chosen to best explain the principles of the embodiments, the practical application, or technical improvement over technologies found in the marketplace, or to enable others of ordinary skill in the art to understand the embodiments disclosed herein.

Where this application refers to “one or more” of something (for example, device parameters or parts of an integrated circuit), it will be appreciated by the skilled person that in the simplest example there may be only one of that something or a there may be a plurality of that something.

1-11. (canceled)

12. A method of determining one or more device parameters (Dp) of one or more parts of an integrated circuit (IC), wherein the one or more device parameters of the one or more parts of the IC are subject to an initially unknown systematic bias, the method comprising:
simulating the IC for each of a plurality of possible systematic biases to provide a plurality of corresponding simulations;
for each systematic bias of the plurality of systematic biases, estimating a respective first device parameter of a first part of the IC from the corresponding simulation, such that a plurality of estimated device parameters is provided;
obtaining a measurement of an electrical characteristic of the first part, and determining a guided estimate of the first device parameter of the first part of the IC using the measured electrical characteristic;
comparing the guided estimate of the first device parameter to each of the plurality of estimated first device parameters, and determining a most likely systematic bias thereby;
obtaining a measurement of one or more electrical characteristics of the one or more parts of the IC; and
using the one or more measured electrical characteristics of the one or more parts of the IC and the simulation corresponding to the most likely systematic bias to determine the one or more device parameters (Dp) of the one or more parts of the IC.

13. The method of claim 12, wherein the systematic bias is a MOSCAP (Cₘ) bias.

14. The method of claim 12, wherein the first device parameter is a threshold voltage (Vth), and wherein the electrical characteristic of the first part is a device leakage current (Ioff).

15. (canceled)

16. (canceled)

17. The method of claim 15, wherein the performing of the measurement of the electrical characteristic of the first part, and the determining of the guided estimate of the first device parameter of the first part of the IC using the measured electrical characteristic, comprise:
measuring the device leakage current (Ioff) of the first device; and
estimating the threshold voltage (Vth) of the first device using an estimator:
f_{isub}(r)=freq(I_{sub_th})/f_{REF}.

18. The method of claim 12, wherein the simulating of the IC for each possible systematic bias comprises:
obtaining one or more expected device parameters from a database of device parameters for the one or more parts of the IC;
simulating the IC by performing Monte-Carlo (MC) simulations using the possible systematic bias and the expected device parameters.

19. The method of claim 12, wherein the performing of the measurement of the one or more electrical characteristics of the one or more parts of the IC comprises:
measuring a current (Id) indicative of the device parameter;
using pulse generation circuitry to generate a pulse having a width, PW(Id), proportional to the measured current (Id);
generating a reference current (IREF);
using the pulse generation circuitry to generate a pulse having a width PW(IREF) proportional to the reference current (IREF); and
calculating the ratio rₘ=PW(Id)/PW(IREF).

20. The method of claim 12, wherein the simulation comprises an estimator f(r) for each device parameter of each part, and wherein the using of the one or more measured electrical characteristics and the simulation to determine the one or more device parameters (Dp) of the one or more parts of the IC comprises:
using the estimator (f(r)) and the ratio (rₘ) to estimate the device parameter:
Dp=f(rₘ).

21. The method of claim 12, wherein the performing of the measurement of the one or more electrical characteristics of a part of the one or more parts of the IC comprises:
biasing the part to induce a condition of the part; and
measuring an electrical characteristic of the part while the part is biased to induce the condition.

22. The method of claim 21, wherein the condition is selected from the group consisting of:
saturation;
weak inversion;
subthreshold; and
breakdown.

23. The method of claim 19, wherein the generating of the reference current (IREF) comprises:
subtracting a feedback voltage from a reference voltage (VREF) to provide an input voltage;
providing the input voltage to the input of a switched capacitor resistor;
using an output of the switched capacitor resistor to provide the feedback voltage; and
using the output of the switched capacitor resistor to generate the reference current (IREF).

24. The method of claim 23, further comprising:
allowing the reference current to become stable in a closed loop position with the feedback voltage being subtracted from the reference voltage so that the feedback loop is locked; and
disconnecting the output of the switched capacitor from the feedback loop to provide an open-loop system.

25. The method of claim 12, wherein the one or more device parameters are selected from the group consisting of:
a threshold voltage (Vth);
a saturation current (Idsat);
a leakage current (Ioff);
a gate capacitance (Cgate);
a diffusion capacitance (Cdiff);
a metal resistance;
a via resistance;
a metal capacitance;
a resistance of an analog device;
a capacitance of an analog device; and
device parameters for devices with a unique channel length.

26. The method of claim 12, wherein the one or more parts are selected from the group consisting of:
components;
device structures comprising a plurality of components;
interconnect paths; and
analog devices.

27. The method of claim 12, wherein:
the one or more parts of the IC comprise one or more replica circuits;
the one or more electrical characteristics of the one or more replica circuits replicate one or more electrical characteristics of one or more sensitive circuits which are prone to malfunction if directly measured; and
the method further comprises determining an improved estimate of one or more device parameters of the one or more sensitive circuits, based on the improved estimate of the one or more device parameters of the one or more replica circuits.

28-34. (canceled)

35. A computer program product for determining one or more device parameters (Dp) of one or more parts of an integrated circuit (IC), wherein the one or more device parameters of the one or more parts of the IC are subject to an initially unknown systematic bias, and wherein the computer program product comprises a non-transitory computer-readable storage medium having program code embodied therewith, the program code executable by at least one hardware processor to:
simulate the IC for each of a plurality of possible systematic biases to provide a plurality of corresponding simulations;
for each systematic bias of the plurality of systematic biases, estimate a respective first device parameter of a first part of the IC from the corresponding simulation, such that a plurality of estimated device parameters is provided;
obtain a measurement of an electrical characteristic of the first part, and determine a guided estimate of the first device parameter of the first part of the IC using the measured electrical characteristic;
compare the guided estimate of the first device parameter to each of the plurality of estimated first device parameters, and determine a most likely systematic bias thereby;
obtain a measurement of one or more electrical characteristics of the one or more parts of the IC; and
use the one or more measured electrical characteristics of the one or more parts of the IC and the simulation corresponding to the most likely systematic bias to determine the one or more device parameters (Dp) of the one or more parts of the IC.

36. The computer program product of claim 35, wherein the first device parameter is a threshold voltage (Vth), and wherein the electrical characteristic of the first part is a device leakage current (Ioff).

37. The computer program product of claim 35, wherein the simulating of the IC for each possible systematic bias comprises:
obtaining one or more expected device parameters from a database of device parameters for the one or more parts of the IC;
simulating the IC by performing Monte-Carlo (MC) simulations using the possible systematic bias and the expected device parameters.

38. The computer program product of claim 35, wherein the performing of the measurement of the one or more electrical characteristics of the one or more parts of the IC comprises:
measuring a current (Id) indicative of the device parameter;
using pulse generation circuitry to generate a pulse having a width, PW(Id), proportional to the measured current (Id);
generating a reference current (IREF);
using the pulse generation circuitry to generate a pulse having a width PW(IREF) proportional to the reference current (IREF); and
calculating the ratio rm=PW(Id)/PW(IREF).

39. The computer program product of claim 38, wherein the generating of the reference current (IREF) comprises:
subtracting a feedback voltage from a reference voltage (VREF) to provide an input voltage;
providing the input voltage to the input of a switched capacitor resistor;
using an output of the switched capacitor resistor to provide the feedback voltage; and
using the output of the switched capacitor resistor to generate the reference current (IREF).

40. The computer program product of claim 35, wherein the simulation comprises an estimator f(r) for each device parameter of each part, and wherein the using of the one or more measured electrical characteristics and the simulation to determine the one or more device parameters (Dp) of the one or more parts of the IC comprises:
using the estimator (f(r)) and the ratio (rm) to estimate the device parameter: Dp=f(rm).
